(19) United States
(12) Patent Application Publication
(10) Pub. No.: US 2012/0331156 A1
(43) Pub. Date: Dec. 27, 2012

(54) WIRELESS CONTROL SYSTEM, METHODS AND APPARATUS

(76) Inventors: Cameron COLPITTS, Seattle, WA (US); Nicolas Flacco, Los Angeles, CA (US)

(21) Appl. No.: 13/443,561

(22) Filed: Apr. 10, 2012

Related U.S. Application Data
(60) Provisional application No. 61/499,200, filed on Jun. 21, 2011.

(51) Int. Cl. G06F 15/16; H04W 8/00

(52) U.S. Cl. 709/227

(57) ABSTRACT

Methods, systems and apparatus for controlling wireless target devices, such as, for example, appliances or other electrically powered devices, or power circuits for providing power to such target devices. A user of a smart device, such as, for example, a cell phone, can conveniently configure the smart device for communication with the target devices, and control the target devices using the smart device via a local network or remotely away from the local network. The target device can broadcast a network for use in configuring the smart device for use in controlling the target device.

### CROSS-REFERENCE TO RELATED APPLICATION(S)

This application claims the benefit of U.S. Provisional Patent Application Ser. No. 61/499,200, filed Jun. 21, 2011, which is incorporated herein by reference in its entirety.

### BACKGROUND

1. Technical Field

The present disclosure relates to control systems, which can operate over a wireless network.

2. Related Art

Home automation systems have existed for some time in the form of standalone, separate timers for VCRs, TVs, climate control systems, security systems, sprinkler systems, etc. However, these timers historically required individual configuration, control, and often used different standards.

Originally automation systems such as the Mirtone intercom system required extra wiring to link appliances, and a separate unit that controlled the entire system. With the advent of the X-10 protocol in the late 1970's, this was no longer necessary as X-10 sent signals over standard power lines (U.S. Pat. No. 4,638,299). By simplifying control and communication, X-10 expanded the market for automation devices. Unfortunately, X-10 systems were and still are subject to interference by neighboring systems if they are physically close and are not encrypted. U.S. Pat. No. 7,092,772 describes a system similar to X-10 but with a more robust design. In a similar vein, U.S. Patent US 2009/0303988 A1 describes an automation system that uses ADSL lines to control user devices.

Currently the state of the art automation systems include full wireless communication between appliances and a control system. Modern X-10 systems allow this, as well as other systems that use derivative, proprietary X-10 standards like INSTEON's SmartLinc (US Patent 20060126617A1). The 802.15.4 Personal Area Network (PAN) standards like ZigBee, and 6LOWPAN offer several additional home automation system options. Patents US 20080016204A1 and 20080056261A1 outline the proprietary ZigBee automation network and gateway device to a standard IP network. Unfortunately, setting up a separate ZigBee or 6LOWPAN PAN gateway introduces extra steps, and the ZigBee standard has become fractured as it has added new services.

Common characteristics of modern automation systems are their complexity, and requirement for expensive, proprietary hardware. Installation and operation of these systems can be complicated and require a high degree of technical competence.

### BRIEF SUMMARY

In some embodiments of the present disclosure, methods are provided for controlling one or more target devices using multiple networks. For example, first, the target device can broadcast a network that a client application can use to establish a communication link between itself and the target device. Second, a user may control target devices by connecting the target device to a local area network as directed through the client application. Third, a client application can control target devices by sending control commands to a remote server, which then routes the control commands to the indicated target devices. Fourth, a client application can control one or more target devices by issuing control commands directly through the local wireless network without passing commands through the remote server.

In some embodiments of the present disclosure, a smart device has a client application installed on it that instructs the smart device. The smart device can include at least one input member, a display, a transmitter, and the client application can include instructions to enable the processor to detect networks broadcasted by one or more target devices, establish communication links between target devices and a local area network, and generate display information on the display that represents the target device. The client application on the smart device can also allow the user to select and send control commands to the target device through a target device's local area network or a remote server.

In some embodiments of the present disclosure, a wireless control system for use in controlling one or more target devices is provided. The system can comprise (1) a user smart device having a processor, input members, display, transmitter, receiver, and an installed client application, (2) a target device having a processor, transmitter and receiver, wherein the target device is capable of changing its controlled state based on a control command, and (3) a remote server connected to the Internet. The target device can establish a communication link on a local area network selectable by the client application, and the local area network can typically communicate with the Internet. A processor of the target device, upon receipt of a signal from the smart device, can automatically send identifier information to be registered at the remote server, and the target device can receive control commands that pass through the remote server and control commands from the smart device on the local area network that do not pass through the server.

### BRIEF DESCRIPTION OF THE DRAWING(S)

FIG. 1 is a simplified overview diagram of a system for some embodiments of the present disclosure. 1

FIG. 2 is a simplified diagram of the target device of FIG. 1, in the form of a power plug.

FIG. 3 is shows an example graphical user interface display for use with some embodiments of the present disclosure.

### DETAILED DESCRIPTION

In the following description, certain specific details are presented in order to provide a thorough understanding of various embodiments of the disclosure. However, upon reviewing this disclosure one skilled in the art will understand that the disclosure may be practiced without many of these details. In other instances, well-known structures, systems and methods associated with computers, wireless devices and networks have not been described in detail to avoid unnecessarily obscuring the descriptions of the embodiments of the disclosure.

In the present description, the terms “a” and “an” as used herein refer to “one or more” of the enumerated components. The use of the alternative (e.g., “or”) should be understood to mean either one, both, or any combination thereof of the alternatives. As used herein, the terms “include” and “comprise” are used synonymously, which terms and variants thereof are intended to be construed as non-limiting. The headings used below are not intend to be limiting.

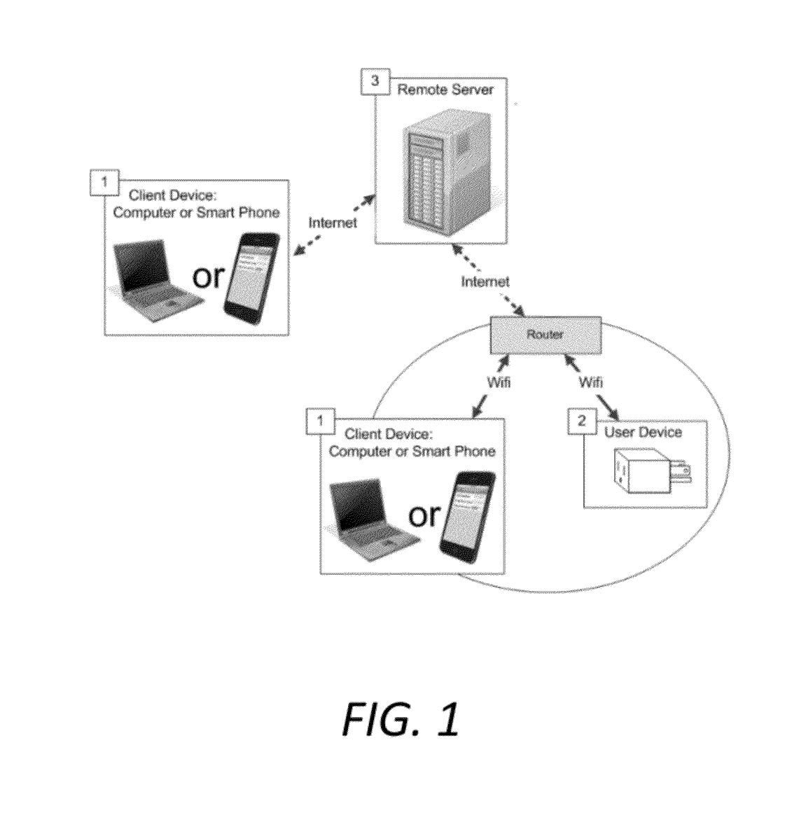

As shown in FIG. 1, in some embodiments of the present disclosure, systems are provided comprising at least one remote server 3, a target device 2, and a client application stored on a user smart device 1. In some embodiments, the system can enable a user with access to a smart device to install the client application on the smart device, and with it, control, monitor and share target devices with other users who also possess a smart device with a compliant client application installed.

### Client Application

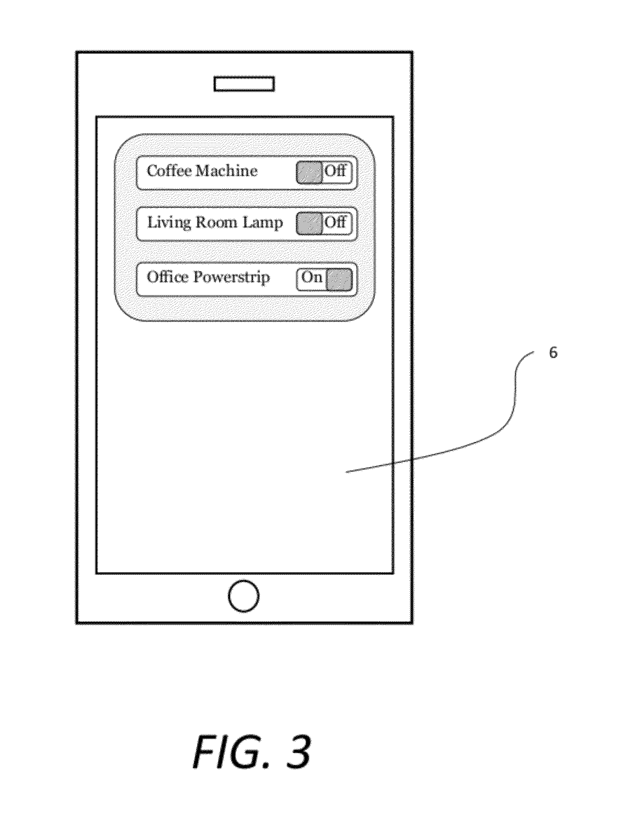

In some embodiments, the client application can be loaded on a memory of a smart device 1, and can provide instruction to the smart device processor. The client application can, among other things, drive the display of target devices 2 on a graphical user interface of a user's smart device, by showing indicia (e.g., names given by the user for target devices) representing target devices 2 associated with the user to allow a user to control the target devices. The graphical user interface could display control graphics, such as, for example, graphical buttons for turning the target device or off, as shown in FIG. 3.

The smart device 1 can be connected to a wireless network, and can be, for example, an 802.11 Wi-Fi enabled smart mobile phone, personal computer, or other smart device. In some embodiments, the client application can perform at least three tasks: target device installation, target device control and monitoring, and target device configuration. Users can interact primarily with the client application so the functions of the client application can largely dictate how users interact with the system. In some embodiments, among the only times a user will not interact directly with the client application is when a physical hardware reset is required, although the system can be configured to offer a remote reset function that should typically obviate the need for direct interaction with the physical user device.

During installation, the client application can automatically sense user target devices that are unable to connect to the application user's wireless network, and prompt the application user to provide the information necessary to connect the user's target device to the wireless network.

In some embodiments, the client application has the ability to automatically discriminate between different types of user target devices that are not connected to the wireless network, and display them separately, on a graphical user interface, in an intelligent, intuitive way to the user. This can be achieved by having the client applications actively query the user target devices that need to be set up, or by having the user target devices create networks with carefully chosen default names that the client applications can decipher as a certain type or class of device.

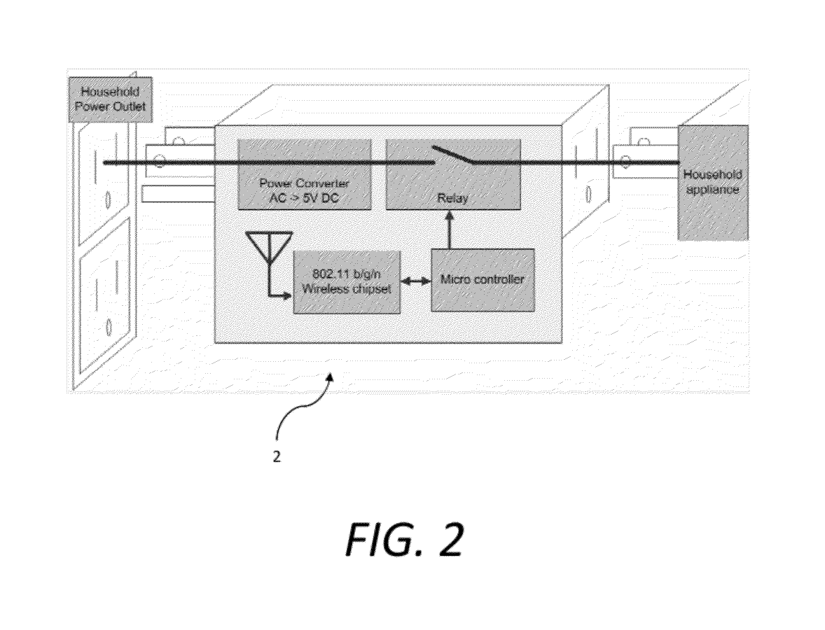

As shown in FIG. 2, the target device can be, for example, a power plug having wireless communications capability, and switch components, which can be comprised of, among other things, a microcontroller and relay, or other controllable components. In this example, any of a variety of appliances or other electrically powered devices, equipment or machinery, or other electrical devices, can be connected to a power source, such as a household power outlet, via the power plug target device, and the target device can be controlled and/or monitored remotely to supply or shut-off power to the connected electrically powered device, or monitor the electrically powered device's power use or state of operation. Under this configuration, the client application will have a two-way communication channel open with an arbitrary number of target devices such that both control and monitoring can be provided for each device. It should be noted that if the client application has access to the Internet, it can also inform the remote server of any state change or device configuration change. Keeping the remote server informed of target device state changes can help ensure that multiple client applications that have access to a single target device continuously and accurately display each target device's true state.

In some embodiments, after the user target devices connect to the user's wireless network, the client application can automatically display installed target devices on the graphical user interface 6 and allow direct user control and configuration of the target devices. Referring to FIG. 3, the target devices can each be given a unique name to be displayed on a display of the user's smart device. Each client application can sense whether it is connected to the same local wireless network that the user target devices are connected to, and be able to change its behavior appropriately. For the sake of low latency performance, both the client application and user target devices can have the flexibility to communicate in different modes that optimize bandwidth use and latency under different circumstances. For example, if the client application is connected to the same wireless network as the user devices, the client application can send control and configuration commands directly to user devices, without sending the primary message to the remote server, which can result in lower latency performance. In this case, the target device 2 can execute a method to keep the remote server 3 and client application 1 in sync, and forward any command to the remote server, if possible. If the target device 2 and client application are not connected to the remote server 3, a method can exist to re-establish synchronization with the remote server upon reconnection, as will be appreciated by one skilled in the art after reviewing this disclosure. One way to do this is for both the remote server 3 and target device 2 to store the time of the last command received, and upon connection, resolve the system state according to the last received command. If the target device 2 stores a more recent command, then that command will take precedence and update the remote server 3. Otherwise, the remote server's 3 most recent command will take precedence, and the target device 2 will change its state according to the remote server's 3 stored command.

If the client application is not connected to the same wireless network as the user devices, several methods of command propagation can be available and may optimize bandwidth and latency performance. In some embodiments, the client application can send commands to a remote server 3. The target device 2 can periodically query the remote server 3, such as in circumstances in which the target device loses connectivity. In other embodiments, a direct communication link can be established between the client application and the user target devices 2, outside of the local wireless network. In some embodiments, from the user's perspective (e.g., how the user interacts with the user interface of the client application), the client application will work identically regardless of whether or not it is connected to the same wireless network as the user devices. The choice of which method to use to implement non-local monitoring and control can depend on a combination of which option optimizes security, bandwidth use, processing overhead, and/or system complexity. It should be noted, however, that periodic polling by the target devices can add to network traffic and system latency. The system latency would be due to both additional traffic on the network, and the period between periodic polling messages by the target devices.

In some embodiments, the client application on the smart device 1 can verify the identity of the user. Several well established methods of identity verification exist, such as a login and password, fingerprint or voice recognition, or something similar. A further level of security can be achieved by using encryption algorithms to prevent third parties from intercepting or faking network data packets.

In addition, standard database security measures can be used to prevent unauthorized users or entities to gain access or control to the states of user devices. Such measures can be employed for reasons such as, for example, preventing abuse of the system or unauthorized control of user target devices.

In some embodiments, control commands will change target device 2 states, while configuration commands will allow application users to change target device 2 name, location tags, add any user target devices that a different application user installed, and other commands that do not directly change target device output state. A standard protocol can be used to send, receive and verify that the client application or user target device 2 successfully sent a command. In addition, client applications can offer users the option to update target device firmware when it becomes available. Updating target device firmware will enable, among other things, the client applications to offer new functionality to users or improve security.

### Target Devices

Target devices 2 can provide power switching, media routing, or any of numerous other operations that an application user wants to control, monitor, or manage. In some embodiments, the target device 2 can, among other things, acquire information from broadcasting an ad-hoc wireless network, listen for control and configuration commands from application clients on the same wireless network, and query a remote server 3 for, or otherwise receive from a remote server 3, control and configuration commands from application clients that are not connected to the same wireless network.

In some embodiments, during installation of a target device 2, each target device can broadcast an ad-hoc wireless network with which a client application (e.g., executing on a smart device) can open a socket connection. With the open socket connection, the target device will receive information from the client application that the target device can use to connect to a user's wireless network selected by the user. The type of wireless network connection can be any of many, such as, for example, an 802.11 WiFi network, BLUETOOTH connection, or 3G wireless connection. In this context, an ad-hoc network is broadly defined as a network that is not connected to the Internet, but one to which other wireless devices can connect to and use to transfer information.

After installation, each target device 2, can simultaneously listen for client applications connected to the same wireless network as the target device (e.g., local users), and either query a remote server 3 or listen for commands from the remote server 3 that originate from client applications that are not connected to the same wireless network as the user smart device (e.g., remote users). By listening for commands from local users on the local area network, the target device can minimize latency (e.g., about several milliseconds or less) during control for users on a local area network. By querying the remote server 3, the target device can also receive control commands, but such control can involve longer, or significantly longer, latencies. Many applications (such as home appliance control) will require very low latency performance to be acceptable to users.

In some embodiments, target devices 2 are well suited for helping track and manage energy consumption, either on behalf of consumers, or third parties, or both. This can be achieved either by connecting the target device wirelessly to a smart meter that a utility (for example) can monitor, or by connecting the target device directly to a utility's remote server, or having the remote server 3 communicate with the utility's remote server directly. A protocol or interface can be provided that provides third party entities, such as, for example, power companies or appliance (or other device) manufacturers access to the state of individual target devices.

With such a connection, third parties and/or consumers could actively regulate real time energy consumption to meet certain optimized conditions. For example, a consumer or business might want to minimize electrical cost by using power during non peak billing hours. This could be achieved by giving control of certain non-vital target devices 2 to a utility, or allowing a utility to send information such as real time power rates to such target devices 2. When a user uses such target devices 2, the utility could warn the user that power is more expensive, and the consumer could opt to delay use of that target device 2. Similarly, target devices 2 could include an option to delay operation until real time power rates come down below a threshold set by a user or the utility. From the point of view of a power transmission or distribution operators, integrated target devices 2 might reduce power purchases on the open market by enabling them to throttle power to individual devices during times when power production capacity was at risk of falling short of demand (or falling short of a certain threshold as a percentage of total capacity). In addition, a grid operator might want to signal the availability of excess capacity, perhaps due to unpredictable renewable sources, such as wind energy, in order to minimize unused capacity. This could be achieved by enabling the power operators to inform client applications that additional power capacity is available. Such an indicator could be achieved via a indicator that shows through color and/or shape, whether the current time is a good time to consume energy.

On a high level, target devices 2 that can be monitored and controlled from remote servers 3 could enable more elastic demand in the electric power markets. The ability to actively manage both electric supply and demand could enable a more reliable, robust grid that is less susceptible to outages, and is more efficient in terms of capital utilization.

In order to avoid target devices receiving conflicting commands from a client application connected to the same wireless network as the target device 2 and commands from the remote server 3, the remote server can be alerted of any command from client applications connected to the same local area wireless network as the target device 2. Either the client application, or the target device itself 2, or both, can send update command messages to the remote server 3.

As will be appreciated by those skilled in the art upon review of this disclosure, many local area networks have firewalls and other well established security measures that can make propagating commands from outside the local area network to the target devices 2 problematic. Thus, in some embodiments, target devices 2 can send queries out to a remote server 3 from within the user's secure wireless network to check for command updates. As such, part of the security the system offers will depend on the security of the wireless network that the user has set up. That is, in some embodiments, the target device can sense the security configuration and automatically adjust its protocol to query the remote server 3 if necessary to receive commands from the remote server 3. Also, the target device 2 can be equipped to communicate over a cellular network to establish communication with the remote server 3 independently from a local area network.

In some embodiments, target devices 2 can also have the ability to accept firmware updates. Client applications on smart device can ask users for permission to update their target devices' firmware. If a user approves firmware updates, the client application can manage firmware updates to one or more of the user's target devices, which may be selectable by the user, connected to the local network. As user demands evolve and new types of configuration and control become desirable, the target devices can be remotely reprogrammed to respond to new commands or communicate with a changed or expanded communications protocol. This flexibility can enable new functionality to be added to existing target devices, and new types of target devices to be introduced without rendering existing user devices obsolete.

### Remote Server

The remote server 3 can act as, among other things, a communications conduit between remote client applications and target devices 2 on the local wireless network. As such, in some embodiments, the remote server 3 may be required to perform at a minimum these tasks:

a) maintain the states of all target devices in the system and associated data, such as timers associated with a target device and power consumption data.

b) provide client applications with all information on the target devices registered with that particular client;

c) communicate any changes (state, name, timers or other) a user makes to a target device to the target device itself as well as to other users of this particular target device;

d) notify the users of a target device if the target device is not communicating with the server;

e) maintain a persistent connection for real-time communication with all target devices; and

f) asynchronously transmit information from target devices to client applications, such as, for example, power data or possibly a button press on the target device itself that can change the state without requiring the user to use a client application to do the state change.

Both remote client applications and target devices 2 can update the remote server via control and configuration commands to ensure that the remote server 3 remains in sync with target device states or undesirable conflicting commands may arise. A message protocol can ensure that communications are flexible, low latency, and reliable. Since user behavior is unpredictable, the protocol can allow arbitrary amounts of information to be sent. In addition, the protocol can allow for automatic network optimization routines that prevent a server overload, and maintain acceptable user latency. Finally, the protocol can take advantage of verification mechanisms to ensure that messages were accurately transferred, as will be appreciated by those skilled in the art after reviewing this disclosure. In some embodiments, the system (remote server 3, target device 2, or client application on the smart device 1, depending on which component becomes aware) can notify users when users send conflicting/contradictory commands and can prevent the system from failing or going into a two-state mode. In a preferred embodiments, there is one true state for every target device.

For some embodiments, the remote server can be thought of as having at least four components, security systems notwithstanding:

a) system that handles persistent connections of target devices and certain clients

b) system that handles periodic data requests from certain clients

c) a common interface (API) that defines what messages the system accepts and what these messages do

d) a database that stores the state of target devices and in general maintains the true state of the entire system.

The remote server is not necessarily a single machine, but can be a cloud based service that embodies the functionality described above across a plurality of individual servers.

If a local client application is not present within range, a target device 2 can periodically query the remote server 3 to see if its state has been changed by a remote client application, or alternatively the remote server can rely on push notifications or persistent sockets to handle real time updates. In this case, the remote server 3 can reply to state requests. The periodicity of target device queries can be automatically changed as a function of network traffic (e.g., the frequency of queries can be adjusted downward as traffic increases, and vice versa). In the case of persistent sockets, the remote server's 3 socket server can also use schemes that prioritize different types of system commands while sending packets over sockets that optimize system performance. For example, user application state change commands might be prioritized above state queries to improve system latency.

In some embodiments, the remote server 3 stores real time state information of target devices 2, along with application user information that associates each target device with an application user account. In some embodiments, at a minimum, the remote server will store information such as user identification information, target devices associated with the user, and each target device's state.

In some embodiments, the systems and methods of the present disclosure can omit the remote server 3. In particular, in some embodiments, only a local network is used to communicate between a client application and a target device. This can provide the user with flexibility to use the system in various ways. For example, by eliminating remote server connectivity, the level of system security will depend on the strength of the local wireless network security. Indeed, in some embodiments, a user can select to discontinue communications with a remote server 3 and utilize only a local area network for communication between target devices and client applications, such as, for example, if security is a concern.

### Installation

In some embodiments of the present disclosure, a system and method is provided for use in installing a controlled, or controllable, target device on an existing wireless network. The network may be, for example, an 802.11 network, BLUETOOTH, or 3G cell network, or something similar. The method can include an active, user-initiated series of steps (which may involve a small number of discrete steps initiated by a user), and an automated action, or series of automated actions, in which the user does not need to do anything. After the target device is installed on the wireless network, a user can use his or her phone (or smart device, which may be a laptop, tablet, etc.) to communicate with, or control the target device.

In some embodiments, the first active step user takes to set up the system is to power on the physical electronic device (target device 2) and initiate or open the client application (e.g., control software application). Powering on the target device 2 can consist of plugging the target device into a standard wall outlet, and switching on the target device (if appropriate), or it can consist of plugging the target device 2 into an AC/DC power supply that will power the device. In parallel with the first step the user can initiate or “open” a software application on a smart device (e.g., smart phone, laptop, or any other smart device that contains a user interface that supports text input and has access to networking assets, such as an 802.11 radio, BLUETOOTH radio, or cell phone radio). Text input can be via a standard keyboard, touch screen, or a voice interface that can transcribe a user's voiced commands into text.

In some embodiments (depending on the smart device's capabilities), a second active step the user can take is to wirelessly connect the smart device 1 to the target device 2, by making appropriate selections using input members and view a display screen on the smart device 1, as will be appreciate by those skilled in the art upon reviewing this disclosure. In a connected state, the smart device will be able to freely send the target device 2 information via packets or whatever other wireless standard has been established. The requirement of whether or not the user needs to manually connect to the target device 2 depends on the capabilities of the smart device 1. For example, some smart devices, depending on operating system, will allow application controlled connections to the target electronic device which makes this step unnecessary, while other smart platforms require the user to manually switch (e.g., by selection using a graphical user interface and input member of the smart device) to the target device's wireless network.

In some embodiments, the third and final step the user will take to set up the target electronic device on the user's wireless network is to send the target electronic device the information necessary for the target electronic device to connect to the user's wireless network. In the case of an 802.11 network, this information can consist of a network name (e.g., SSID) and passphrase. Some modern embedded wireless systems can automatically detect what type of authentication and security a wireless network is using, so it is not necessary for the user to enter the type of authentication. Other types of wireless networks (such as, for example, BLUETOOTH or 3G networks) may require other information to enable the target electronic device to connect. In some embodiments, after sending the information necessary to connect to the user's wireless network to the target electronic device, the remainder of the method steps are automated. Upon successful setup, the application will display the target electronic device by, for example, indicating its state, name, and any other relevant information on a display of the user's smart device, with the target device being enabled for control through the client application.

In some embodiment, in the case of failure to set up the target electronic device due to, for example, mistyping information, or a faulty wireless connection, the target electronic device can revert to its original un-configured state, and the client application can detect and indicate the source or cause of the failure and instruct the user to try to set up the target device again, and provide (display or otherwise indicate) to the user the potential source or cause of the failure by, for example, reminding the user to double check a particular step in the setup process that may be related to the source of the failure. Steps that can go wrong include, but are not limited to: failing to power on a target device, mistyping the user's wireless network name, mistyping the user's wireless network passphrase, or having a wireless network that has controlled access. In any of these error cases, the user can receive feedback that can be used to avoid errors on subsequent setup attempts.

### Automated Set-Up Process

In some embodiments, there are three parts of the automated portion of the system: the target device 2, the client application on the smart device 1, and a remote server 3, all of which may work in concert to provide the user an easy, secure way to set up the target device.

The processor (e.g., microcontroller) of the target device 2 may detect whether or not it is able to connect to the user's wireless network by, for example, scanning all the available networks, and matching the scan results to a list of stored networks. If it is unable to find a match in the scanned networks and is unable to connect to the user's wireless network, the target device 2 may automatically become a network node itself, or enter a mode in which the client application can wirelessly connect directly to the target device. A network node may allow a smart device to connect to it and transmit information both ways as will be appreciated by those skilled in the art after reviewing this disclosure. The smart device 1 and target device 2 can use any network protocol, such as, for example, wi-fi, BLUETOOTH, 3g, 4g, as long as the protocol allows two way information transfer. The ability for the target device to automatically configure itself to allow the client application to directly connect can be necessary to provide the user's client application a conduit to set up the target electronic device. In addition, in the case where the target device sets up an independent network node, the target device may be pre-equipped with sufficient firmware instruction to avoid redundant network node names by scanning the existing names of wireless networks, and automatically changing the default name of the network name to something unique.

In some embodiments, after the target device 2 has received information to connect to the user's wireless network, and has succeeded, it can automatically connect to a remote server 3 via the internet. Once connected to the server on the internet, the target device can automatically send a message that uniquely registers itself in the remote server's 3 database (which can include at least a unique identifier for the target device and the smart device of a user that set up the target device). This functionality can be necessary to enable the target device 2 to be automatically displayed on a client application on the smart device 1 after the user has finished the user's active portion of this set up method. That is, the user can then obtain or receive status information for the target device from the server, and can have access to control the target device via the server 3.

After registering with the remote server, the target device itself maintains a state that supports the real time reception and transmission of asynchronous data with respect to the remote server 3. This can be achieved in various ways. For example, real time persistent communication can be achieved via push notifications from the remote server 3 to the target device 2 and client application on the smart device 1. Second, persistent socket connections between the remote server 3 and both the target electronic device 2 and smart device 2 can be maintained. Or, third, the persistent real time connection can be achieved via periodic polling method in which the target electronic device or smart device application periodically connect and query the remote server for updates.

In some embodiments, the client application on the smart device 1 must support the ability to connect to and receive information from both target devices that have not been set up, and the remote server. After connecting with the target device 2, the client application can prompt the user for the information needed for the target device to connect to the user's wireless network. It should be noted that some smart devices support applications that can automatically detect and connect to multiple wireless networks. In this case, all wireless network management is handled automatically, which leads to the desirable outcome in which the user does not have to manage switching between wireless networks at all.

After prompting the user for information to connect to the user's wireless network, the client application can send this information to the target device 2 along with the user's unique identification information. The client application can then wait for confirmation from the remote server 3 that the new target device 2 has successfully been registered with the remote server 3. If the set up process is successful, the new target electronic device can be monitored and controlled by the user.

If the process fails, the client application on the smart device 1 can inform the user the next time the same target device 2 is being set up as to what may have went wrong the first time, and recommend a fix, as will be appreciated by those skilled in the art after reviewing this disclosure. This functionality can minimize user frustration, and enable problems to be fixed without external intervention.

In some embodiments, the smart device client application can easily switch between wireless networks being accessed because such a functional feature can enable the client application to both guide the user through the active set up steps, and keep the user aware of what the target device 2 is doing after the user has finished executing the active set up steps. Both guidance and feedback are necessary to this method, and the ability for the smart device application to connect to multiple sources of information allows this.

Finally, although the remote server 3 is not visible to the user, in some embodiments, it enables the client application on the user's smart device 1 to communicate with the target device 2. The first time the remote server 3 receives a connection from a target device 2, it can (a) add the target device's unique identifier to its database, and (b) send a message to the smart device 1 client application, notifying it that a new target device with a given unique identifier has been added to the system. In some embodiments, the target device's initial message to the remote server includes a unique user identifier, identifying the smart device of the user that that set up the target device. With this user identifier, the remote server is aware of which user set up the device, so it only sends a notification to the smart device of the single user who set up the target device.

The client application on the smart device 1 can support sharing between different users so that multiple users having different smart devices can monitor and control any particular target device 2. This can be facilitated in the remote server by keeping track of which target devices are associated with which users, and allowing a single target device to be associated with multiple users. An association between a target device and user smart device, can be created by sending to the remote server, from the smart device 1, a message indicating that a new specified user be henceforth associated with a target device with a given unique identifier. When a device is shared this way with a new user, the new user will receive a notification from the remote server about the target device's existence, and that new user will then be able to monitor and control the target device.

In some embodiments of the present invention, the following steps may be executed:

(a) the target device 2 broadcasts a network which is accessible by a locally positioned user smart device;

(b) the smart device detects the network and the client application signals the target device to enter a setup mode;

(c) in the setup mode, the target device sends information identifying the networks it has detected to the client application via the smart device;

(d) the client application then either automatically, or by prompting the user to provide information, directs the target device to access a network by providing particular network information (e.g., network name (e.g., SSID) and passphrase);

(e) the target device then connects to the specified network, and then accesses a remote server 3 through the specified network to the Internet, and registers with the remote server (which may include providing a unique identifier for the target device and a unique identifier for the smart device associated with the user that initiated setup for the target device); and

(f), the remote server notifies the target device to confirm registration and notifies the smart device of the registration of the target device.

Although specific embodiments and examples of the disclosure have been described supra for illustrative purposes, various equivalent modifications can be made without departing from the spirit and scope of the disclosure, as will be recognized by those skilled in the relevant art after reviewing the present disclosure. The various embodiments described can be combined to provide further embodiments. The described systems, graphical user interfaces, devices and methods can omit some elements or acts, can add other elements or acts, or can combine the elements or execute the acts in a different order than that illustrated, to achieve various advantages of the disclosure. These and other changes can be made to the disclosure in light of the above detailed description. The Summary section of this specification is not intended to identify key features or essential features of the claimed subject matter, nor is it intended to be used as an aid in determining the scope of the claimed subject matter.

In general, in the following claims, the terms used should not be construed to limit the disclosure to the specific embodiments disclosed in the specification.

What is claimed is:

1. A method for controlling and monitoring a target device, the target device having wireless communication capabilities and a processor, the method comprising the following steps in any order:
broadcasting a network from the target device usable for establishing a communication link between the target device and a client application;
connecting the target device to a local area or wide area network as directed through the client application;
receiving at the target device, a control command from a remote server, the control command having been issued from the client application to the remote server;
sending to the remote server, a message from the target device or the client application;
sending to the client application, a message from the target device; and
receiving a control command at the target device directly from the client application, the control command being issued through the local area network without having passed through the remote server.

2. The method of claim 1 wherein receiving the control command at the target device from a remote server comprises the target device sending a query to the remote server to access information regarding control commands having been sent from one or more client applications.

3. The method of claim 1 wherein receiving the control command at the target device from the remote server comprises opening a socket connection.

4. The method of claim 1 wherein receiving the control command at the target device from the remote server comprises receiving a push notification from the remote server to the target device.

5. The method of claim 1 further comprising transmitting information from the target device to the local network, and then from the local area network to the remote server for registration at the remote server, the information identifying the target device and the smart device used to initiate the registration.

6. The method of claim 5 wherein the client application is used to instruct the target device to cease communication with the remote server and to communicate only with the client application through the local area network.

7. The method of claim 5 further comprising transmitting confirmation of registration of the target device at the remote server to the client application on the smart device.

8. The method of claim 1 further comprising the client application receiving notification of a firmware update, and displaying an inquiry to the user to select whether to install the firmware update on the target device.

9. The method of claim 1 wherein the target device includes a power connector circuit for use in providing a circuit between an appliance and a power source, and wherein the control commands include commands for closing or opening the circuit.

10. A system for use in controlling a target device comprising:
a target device having wireless communication components and a processor, the target device being operable to broadcast a network accessible by a locally positioned smart device;
a client application on the smart device operable for automatically communicating with the target device upon detecting the broadcasted network to inform the target device that the broadcasted network has been detected, such that the target device automatically enters a setup mode, the setup mode including the target device sending information to the smart device to identify other networks detected by the target device, the client application further being operable for use in sending a command to the target device to direct the target device to select access one of the identified networks by providing particular network information unique to the selected network; and
a remote server operable to receive a message from the target device to register the target device at the remote server and to send a confirmation signal to the target device indicating that the remote server has registered the target device, wherein the client application can send commands to the target device through the remote server or directly to the target device through the selected network.

11. The system of claim 10 wherein registering the target device at the remote service includes storing unique identification information for the particular target device, in association with unique identification information identifying a user.

12. A smart device comprising:
at least one input member;
a display;
a transmitter; and
a processor operable for detecting a network broadcasted by a target device, for establishing a communication link between the target device and a local area network, and for displaying indicia on the display representing the target device for allowing the user to select to send control commands to the target device through the local area network or a remote server.

13. The smart device of claim 12 wherein the processor is operable to receive a notification from a remote server indicating that the target device has been registered on the remote server.

14. The smart device of claim 12 wherein the processor is operable to query the remote server periodically to access information regarding a control state of the target device.

15. The method of claim 12 wherein the processor is operable to maintain a persistent socket connection with the remote server.

16. The method of claim 12 wherein the processor is operable to receiving a push notification from the remote server regarding a control state of the target device.

17. The method of claim 12 wherein the processor is operable for generating on the display, a list of networks detected by the target device and for use in selecting one of the networks to direct the target device to connect to the network.

18. The method of claim 12 wherein the processor is operable for displaying a graphical selection member usable to instruct the target device not to act on any control commands issued by the remote server.

19. A wireless control system for use in controlling a target device, the system comprising:
a user smart device having a processor, a memory system, input members, display, transmitter and receiver;
a target device having a processor and transmitter and receiver, the target device being capable of changing its controlled state based on a control command sent from the smart device;
a remote server connected to the Internet;
wherein the target device can establish a communication link on a local area network selectable by the smart device, and wherein the local area network is communicatively linked to the Internet;
wherein a processor of the target device, upon receipt of a signal from the smart device, is operable to automatically send identifier information to be registered at the remote server; and
wherein the target device is operable to change its controlled state as a function of control commands that pass through the remote server from the smart device and control commands sent from the smart device on the local area network that do not pass through the remote server.

20. The control system of claim 19 wherein the identifier information includes both identifier information for the target device and for the smart device used to initiate set up of the target device.

21. The control system of claim 19 wherein the target device generates a network to be detected by the smart device before it is connected to the smart device.

22. The control system of claim 19 wherein the processor of the smart device is operable to generate a command to the target device to instruct the target device to receive commands only from the local network and not the remote server.

23. The control system of claim 19 wherein the processor of the target device is operable to query the remote server periodically to access information regarding a control state of the target device.

24. The control system of claim 19 wherein the processor of the target device is operable to maintain a persistent socket connection with the remote server.

25. The control system of claim 19 wherein the client application is operable for use in granting control or monitoring access for the target device to client applications residing on other smart devices.

26. The control system of claim 19, wherein the target device is operable to be regulated as a function of up to date energy availability or cost information.
